(19) United States
(12) Patent Application Publication
(10) Pub. No.: US 2013/0101320 A1
(43) Pub. Date: Apr. 25, 2013

(54) DEVELOPING DEVICE AND IMAGE FORMING APPARATUS

(71) Applicants: Hideki OKAMOTO, Kanagawa (JP); Yoichi WATANABE, Kanagawa (JP)

(72) Inventors: Hideki OKAMOTO, Kanagawa (JP); Yoichi WATANABE, Kanagawa (JP)

(73) Assignee: FUJI XEROX CO., LTD., Tokyo (JP)

(21) Appl. No.: 13/453,925

(22) Filed: Apr. 23, 2012

(30) Foreign Application Priority Data
Oct. 25, 2011 (JP) 2011-233756

(51) Int. Cl. G03G 15/09

(52) U.S. Cl. 399/274

(57) ABSTRACT

A developing device includes a developer transport body having a rotating outer peripheral surface, a magnet member having a plurality of magnetic poles, a regulation member that regulates passage of the developer supplied on the outer peripheral surface, and an introduction member having an opposing face opposing the outer peripheral surface to form an introduction space. A regulation-assist magnetic pole, of the magnetic poles, is provided at a position shifted from a position opposing the regulation member toward an upstream side in a rotating direction of the developer transport body. At least an upstream end of the opposing face is located on a virtual line obtained by translating a tangent line to the developer transport body at a position opposing the regulation member to an end of the regulation member opposing the developer transport body or located closer to the outer peripheral surface than the virtual line.

### CROSS-REFERENCE TO RELATED APPLICATIONS

This application is based on and claims priority under 35 USC 119 from Japanese Patent Application No. 2011-233756 filed Oct. 25, 2011.

### BACKGROUND

(i) Technical Field

The present invention relates to a developing device and an image forming apparatus.

(ii) Related Art

Image forming apparatuses, such as a printer, a copying machine, and a facsimile machine, using an image recording method, such as an electrophotographic method or an electrostatic recording method, are equipped with developing devices for developing an electrostatic latent image formed on a latent-image carrier, such a photoconductor, with developer.

Among such developing devices, there is a developing device including at least a developing roller that holds developer showing magnetism by magnetic force and rotates to transport the developer to a developing region opposing a latent-image carrier, and a regulation member set such that an end thereof is kept at a predetermined distance from the developing roller. The regulation member uniformly regulates the layer thickness (transport amount) of developer to be supplied to a surface of the developing roller and transported to the developing region. Here, developer showing magnetism is, for example, a two-component developer containing nonmagnetic toner and magnetic carriers, or a magnetic one-component developer. For example, the developing roller is a developer holding transport body including a rotary cylindrical transport member, and a magnet member fixed to an inner side of the transport member to generate magnetic force lines for holding the developer on an outer peripheral surface of the transport member by magnetic force.

### SUMMARY

According to an aspect of the invention, there is provided a developing device including: a substantially cylindrical developer transport body having an outer peripheral surface that rotates to transport developer showing magnetism; a magnet member fixed to an inner side of the developer transport body and having a plurality of magnetic poles extending in an axial direction of the developer transport member, the magnetic poles being spaced in a rotating direction of the developer transport body; a platelike regulation member that regulates passage of the developer supplied on the outer peripheral surface of the developer transport body to maintain a predetermined transport amount of the developer, the regulation member extending in the axial direction of the developer transport body to oppose the outer peripheral surface of the developer transport body with a predetermined gap therebetween; and an introduction member provided in contact with a face portion of the regulation member on an upstream side in the rotating direction of the developer transport body, and having an opposing face opposing the outer peripheral surface of the developer transport body to form an introduction space where the supplied developer is introduced toward the gap between the regulation member and the developer transport body. A regulation-assist magnetic pole for assisting in regulation of the regulation member, of the plurality of magnetic poles in the magnet member, is provided at a position shifted from a position opposing the regulation member toward the upstream side in the rotating direction of the developer transport body to oppose a part of the opposing face of the introduction member. The opposing face of the introduction member is provided such that at least an end of the opposing face provided on the upstream side in the rotating direction of the developer transport body is located on a virtual line obtained when a tangent line to the developer transport body at a position opposing the regulation member is translated to an end of the regulation member opposing the developer transport body or is located closer to the outer peripheral surface of the developer transport body than the virtual line.

### BRIEF DESCRIPTION OF THE DRAWINGS

Exemplary embodiments of the present invention will be described in detail based on the following figures, wherein:

FIG. 1 illustrates the principal part of an image forming apparatus using a developing device according to an exemplary embodiment;

FIG. 2 is a schematic cross-sectional view of the developing device used in the image forming apparatus of FIG. 1;

FIG. 3 is an enlarged view of the principal part (e.g., developing rollers, a regulation plate, and an introduction member) of the developing device of FIG. 2;

FIG. 4 illustrates a structure of a characteristic part (e.g., a magnetic pole for regulation assist and an opposing face of the introduction member) of the developing device of FIG. 2;

FIG. 5 is a graph showing the relationship (characteristic) between the pressure and the viscosity coefficient of developer;

FIG. 6 illustrates a structure of a characteristic part of the developing device of FIG. 2 and a pressure distribution state of the developer in the characteristic part;

FIG. 7 illustrates a structure of a comparative example in contrast to the characteristic part of the developing device of FIG. 2 and a pressure distribution state of developer in the comparative example;

FIG. 8 illustrates a structure of another comparative example in contrast to the characteristic part of the developing device of FIG. 2:

FIG. 9 illustrates a pressure distribution state of developer in the comparative example of FIG. 8; and

FIG. 10 illustrates a structure of a characteristic part (e.g., a magnetic pole for regulation assist and an opposing face of an introduction member) of a developing device according to another exemplary embodiment.

### DETAILED DESCRIPTION

Exemplary embodiments of the present invention will be described below with reference to the drawings.

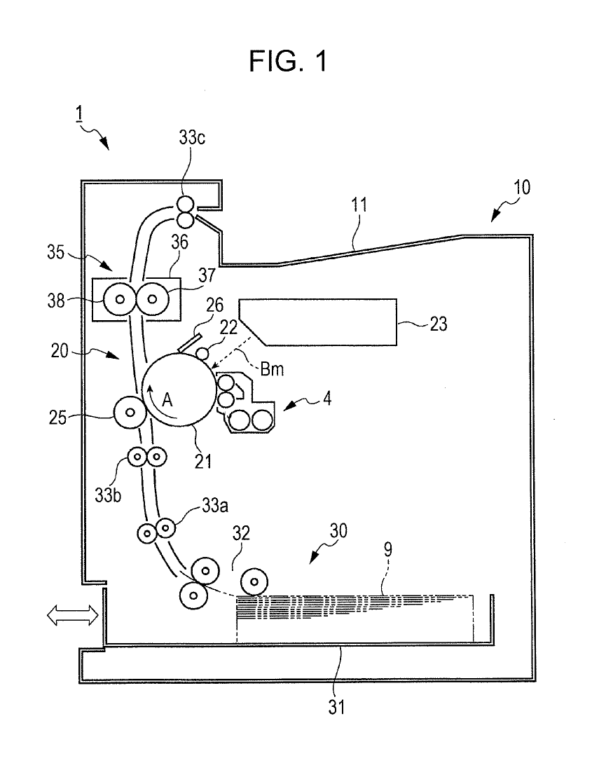

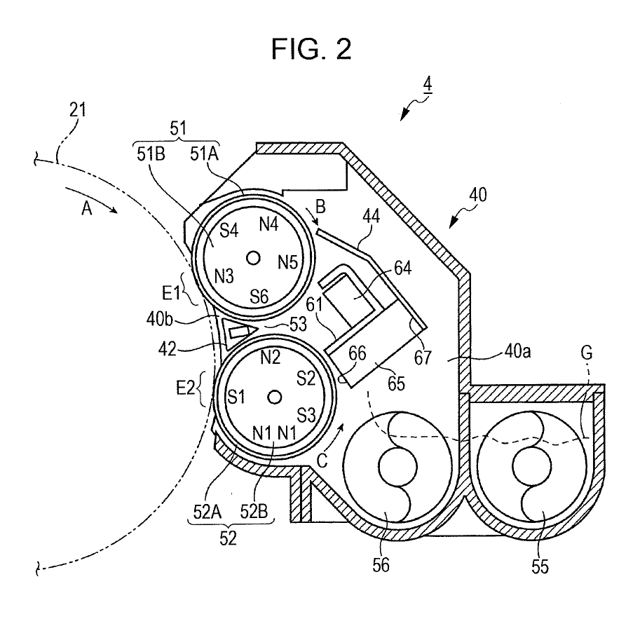

FIGS. 1 and 2 illustrate an image forming apparatus 1 to which a developing device 4 according to an exemplary embodiment is applied. FIG. 1 schematically illustrates the image forming apparatus 1, and FIG. 2 schematically illustrates the developing device 4.

As illustrated in FIG. 1, the image forming apparatus 1 includes, in an inner space of a housing 10 formed by a support member, an exterior material, etc., an image forming device 20 that forms a toner image with developer and transfers the toner image onto a sheet 9, a paper feed device 30 that stores and feeds out sheets 9 to be supplied to the image forming device 20, and a fixing device 35 that fixes the toner image transferred by the image forming device 20 onto a sheet 9.

For example, the image forming device 20 utilizes a known electrophotographic method. The image forming device 20 principally includes a photoconductor drum 21, a charging unit 22, an exposure unit 23, a developing device 4, a transfer unit 25, and a cleaning unit 26. The photoconductor drum 21 rotates in a direction of arrow A (a clockwise direction in the figures). The charging unit 22 charges a peripheral surface of the photoconductor drum 21 to the required potential. The exposure unit 23 forms an electrostatic latent image having a potential difference by applying light Bm based on image information (signals) onto the charged peripheral surface of the photoconductor drum 21. The developing device 4 develops the electrostatic latent image with toner serving as developer into a toner image. The transfer unit 25 transfers the toner image onto a sheet 9. The cleaning unit 26 removes toner and the like remaining on the peripheral surface of the photoconductor drum 21 after transfer.

As the photoconductor drum 21, for example, a photosensitive layer made of an organic conductive material is formed on an outer peripheral surface of a grounded cylindrical conductive base body. The charging unit 22 is of a contact type or a non-contact type. The exposure unit 23 is formed by a laser beam scanning unit using a semiconductor laser and various optical components in combination, or an LED array using a plurality of light-emitting diodes (LEDs) and various optical components in combination. The exposure unit 23 performs exposure by applying light Bm based on an image signal that is obtained by subjecting image information to required processing in an unillustrated image processing device. The image information is input from an image generation source connected to or mounted in the image forming apparatus 1, for example, a document reading device, an external connection device, or a storage-medium reading device.

The developing device 4 uses two-component developer G containing nonmagnetic toner and magnetic carriers (particles). As illustrated in FIG. 2 and other figures, the developing device 4 adopts two developing rollers 51 and 52. Details of the developing device 4 will be described below.

The transfer unit 25 is of a contact type or a non-contact type. In the cleaning unit 26, for example, a cleaning blade in contact with the peripheral surface of the photoconductor drum 21 is also in contact with a rotary brush. When an image forming operation is performed, a charging voltage, a developing voltage, and a transfer voltage are supplied from an unillustrated power supply device to the charging unit 22, the developing device 4 (developing rollers 51 and 52), and the transfer unit 25, respectively.

The paper feed device 30 includes a paper container 31 in which a plurality of sheets 9 of the required size or type to be used for image formation are stacked, and a feeding unit 32 that feeds out the sheets 9 stored in the paper container 31 one by one toward a sheet transport path. In image formation, the paper feed device 30 feeds out and supplies necessary sheets 9 one by one to a transfer position in the image forming device 20. The paper container 31 is attached to be drawn into and out of the housing 10 in a direction of a double-headed arrow. According to the usage manner, a plurality of paper containers 31 are mounted.

In the housing 10, there is provided a transport path in which a sheet 9 fed out from the paper feed device 30 is transported to the transfer position in the image forming device 20 and is further transported to an output and storage portion 11 provided in an upper part of the housing 10. The transport path is defined by a plurality of pairs of transport rollers 33a, 33b, and 33c, a transport guide member, etc.

The fixing device 35 has a heating rotating body 37 and a pressurizing rotating body 38 in a casing 36. The heating rotating body 37 is shaped like a roller or a belt that is rotationally driven, and a surface thereof is heated by a heater to maintain a required surface temperature. The pressurizing rotating body 38 is shaped like a roller or a belt that is rotated along with the rotation of the heating rotating body 37 while being in contact with the heating rotating body 37 almost in an axial direction with a required pressure. In the fixing device 35, fixing is performed by passing a sheet, on which a toner image is transferred, through a fixing portion provided between the heating rotating body 37 and the pressurizing rotating body 38.

The image forming apparatus 1 performs image formation as follows. Here, a basic image forming operation for forming an image on one surface of a sheet 9 will be described as an example.

When the image forming apparatus 1 receives a command to start an image forming operation, the photoconductor drum 21 starts rotation, the outer peripheral surface of the photoconductor drum 21 is charged to a predetermined polarity and a predetermined potential by the charging unit 22 in the image forming device 20, and the charged outer peripheral surface of the photoconductor drum 21 is exposed by the exposure unit 23 according to image information, so that an electrostatic latent image having a required potential difference is formed. Subsequently, the electrostatic latent image formed on the photoconductor drum 21 is developed with toner of developer G supplied from the two developing rollers 51 and 52 into a visual toner image while passing through the developing device 4.

After that, the toner image formed on the photoconductor drum 21 is transported to the transfer position opposing the transfer unit 25 by the rotation of the photoconductor drum 21, and is transferred by the transfer unit 25 onto a sheet 9 supplied from the paper feed device 30 through the transport path at a proper timing. After transfer, the peripheral surface of the photoconductor drum 21 is cleaned by the cleaning unit 26.

Next, the sheet 9 on which the toner image is transferred is separated from the photoconductor drum 21, and is transported into the fixing portion in the fixing device 35. When the sheet 9 is heated and pressurized while passing through the fixing portion between the heating rotating body 37 and the pressurizing rotating body 38 in the fixing device 35, the toner image is fixed. After fixing, the sheet 9 is transported out from the fixing device 35, and is output and stored in the output and storage portion 11.

Through the above steps, a monochrome image is formed by toner of one color on one surface of one sheet 9, and the basic image forming operation is completed. When there is a request to perform an image forming operation for a plurality of sheets, the above-described series of steps are similarly repeated the number of times corresponding to the requested number of sheets.

Next, the developing device 4 will be described in detail.

As illustrated in FIGS. 2 to 4, the developing device 4 has a body section 40 including a storage chamber 40a that stores the above-described two-component developer G, and a rectangular opening portion 40b provided at a position opposing the photoconductor drum 21. The body section 40 is shaped like a long container having a length more than an axial length of the photoconductor drum 21. A bottom portion of the storage chamber 40a has two parallel developer circulating and transporting paths (grooves) that are connected to each other at both ends in a longitudinal direction of the long container and are separated by a partitioning raised portion extending in the longitudinal direction. The developer G is stored in the storage chamber 40a.

In the body section 40 of the developing device 4, there are provided two developing rollers 51 and 52 (a first developing roller 51 and a second developing roller 52), two screw augers 55 and 56, a regulation plate 61, an introduction member 65, a separating member 42, and a guide plate 44. The first developing roller 51 and the second developing roller 52 transport the developer G to developing regions opposing the photoconductor drum 21 at two positions while holding the developer G by magnetic force. The screw augers 55 and 56 serve as agitation and transport members that agitate and transport the developer G stored in the storage chamber 40a. The regulation plate 61 restricts the passage of the developer G supplied from the screw auger 56 to the second developing roller 52 so as to regulate the layer thickness (transport amount) of the developer G. The introduction member 65 has an opposing face 66 that defines an introduction space M where the developer G supplied to the second developing roller 52 is guided into a gap J between the second developing roller 52 and the regulation plate 61. The separating member 42 separates the developer G transported from the second developing roller 52 to the first developing roller 51 and the second developing roller 52. The guide plate 44 guides and returns the developer G separated from the first developing roller 51 into the storage chamber 40a.

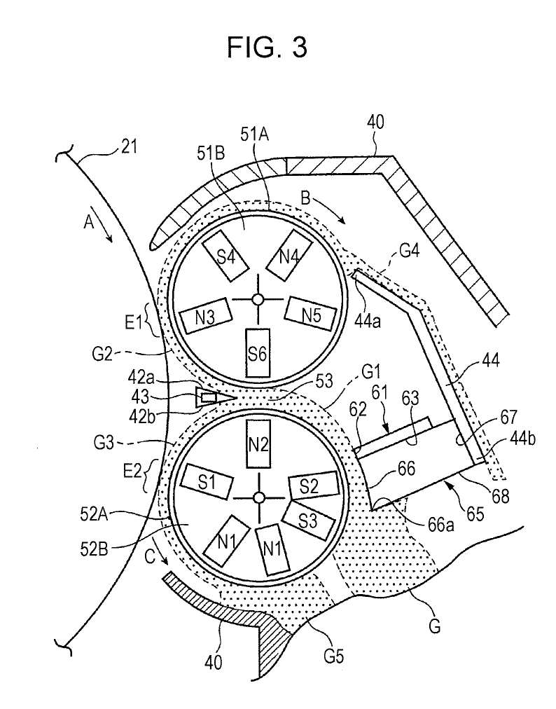

As illustrated in FIGS. 2 and 3, the first developing roller 51 and the second developing roller 52 rotate in predetermined directions B and C, respectively, while being partially exposed from the opening portion 40b of the body section 40. The two developing rollers 51 and 52 are arranged at a predetermined distance from each other. A portion (space) where the developing rollers 51 and 52 are closest to each other serves as a closest portion 53.

The first developing roller 51 includes a cylindrical or substantially cylindrical sleeve 51A that rotates in the direction of arrow B at a position close to a first developing region E1 of the photoconductor drum 21, and a magnet roller 51B fixed to an inner side of the sleeve 51A. The rotating direction B of the sleeve 51A is set such that the moving direction of the sleeve 51A in the first developing region E1 of the photoconductor drum 21 is opposite the rotating (moving) direction A of the photoconductor drum 21. In contrast, the second developing roller 52 includes a cylindrical or substantially cylindrical sleeve 52A that rotates in the direction of arrow C at a position close to a second developing region E2 on a downstream side of the first developing region E1 of the photoconductor drum 21, and a magnet roller 52B fixed to an inner side of the sleeve 52A. The rotating direction B of the sleeve 52A is set such that the moving direction of the sleeve 52A in the second developing region E2 of the photoconductor drum 21 is the same as the rotating (moving) direction A of the photoconductor drum 21.

The sleeves 51A and 52A are formed of a nonmagnetic material (e.g., stainless steel or aluminum) and are each shaped to have a cylindrical portion with an almost the same width (length) as that of an effective image forming region of the photoconductor drum 21 in the rotation axis direction. The sleeves 51A and 52A oppose the photoconductor drum 21 such that the rotation axis directions thereof are substantially parallel to the rotation axis direction of the photoconductor drum 21. Further, shaft portions at both ends of each of the sleeves 51A and 52A are rotatably supported by side portions of the body section 40. The sleeves 51A and 52A are rotated in the directions of arrows B and C, respectively, by power transmitted from an unillustrated rotating device via the shaft portions. In addition, a developing voltage is applied from an unillustrated power supply device to the sleeves 51A and 52A so as to form developing electric fields between the sleeves 51A and 52A and the photoconductor drum 21. The developing voltage to be applied is, for example, a direct-current voltage on which an alternating-current component is superimposed.

In the magnet rollers 51B and 52B, a plurality of magnetic poles (S-poles and N-poles) are arranged to generate magnetic force lines such that magnetic carries in the developer G are held in the form of magnetic brushes on the outer peripheral surfaces of the sleeves 51A and 52A. For example, the magnet rollers 51B and 52B are attached with both ends being fixed to the side portions of the body section 40 through inner spaces of the shaft portions of the sleeves 51A and 52A. A plurality of magnetic poles extend in the axial direction of the sleeves 51A and 52A, and are provided at required positions spaced from each other in the circumferential direction (rotating direction) of the sleeves 51A and 52A.

As illustrated in FIGS. 2 and 3, five magnetic poles S6, N3, S4, N4, and N5 are provided in the magnet roller 51B of the first developing roller 51. Among these magnetic poles, the magnetic pole S6 is located at a position closest to the second developing roller 52 (closest position), and serves as a transport pole that transports the developer G supplied from the second developing roller 52 onto the outer peripheral surface of the sleeve 51A while attracting the developer G by magnetic force. The magnetic pole N3 is located at a position opposing the first developing region E1 of the photoconductor drum 21, and serves as a developing pole that contributes the developer G to a developing process. The magnetic pole S4 serves as a transport pole, and the magnetic poles N4 and N5 perform pickoff for separating the developer G from the outer peripheral surface of the sleeve 51A.

As illustrated in FIGS. 2 and 3, six magnetic poles S3, S2, N2, S1, N1, and N1 are arranged in the magnet roller 52B of the second developing roller 52. Among these magnetic poles, the magnetic pole S3 is located at a position substantially opposing a photoconductor-drum-21-side upper end of the screw auger 56 that is close to the second developing roller 52. The magnetic pole S3 performs pickup for attracting and holding the developer G supplied from the screw auger 56 onto the outer peripheral surface of the sleeve 52A by magnetic force. The magnetic pole S2 serves as a regulation-assist pole that stands magnetic brushes in a required size in order to assist in developer regulation of the regulation plate 61. The magnetic pole N2 serves as a transport pole located at a position opposing the transport pole S6 in the first developing roller 51. The magnetic pole S1 is located at a position opposing the second developing region E2 of the photoconductor drum 21, and serves as a developing pole that contributes the developer G to the developing process. The magnetic poles N1 and N1 perform pickoff for separating the developer G from the outer peripheral surface of the sleeve 52A by generating magnetic repulsive force.

Particularly in the magnet roller 52B of the second developing roller 52, the regulation-assist magnetic pole S2 is located at a position shifted from a position opposing the regulation plate 61 toward an upstream side in the rotating direction C of the sleeve 52A so as to oppose a part of the opposing face 66 of the introduction member 65. More specifically, the magnetic pole S2 is located at a position such that a curve (magnetic force line) representing the magnetic flux density in the normal direction does not act on at least the regulation plate 61.

As illustrated in FIG. 2, transport blades are spirally wound around peripheral surfaces of the rotation shafts of the screw augers 55 and 56. The screw augers 55 and 56 are rotatably set in the above-described developer circulating and transporting paths in the storage chamber 40a of the body section 40, and rotate in directions to transport the developer G in the transporting paths in required directions. The screw augers 55 and 56 are rotated by transmission of a part of power from the rotating device for rotating the sleeves 51A and 52A. The screw auger 56 located near the second developing roller 52 supplies, to the second developing roller 52, a part of the transported developer G.

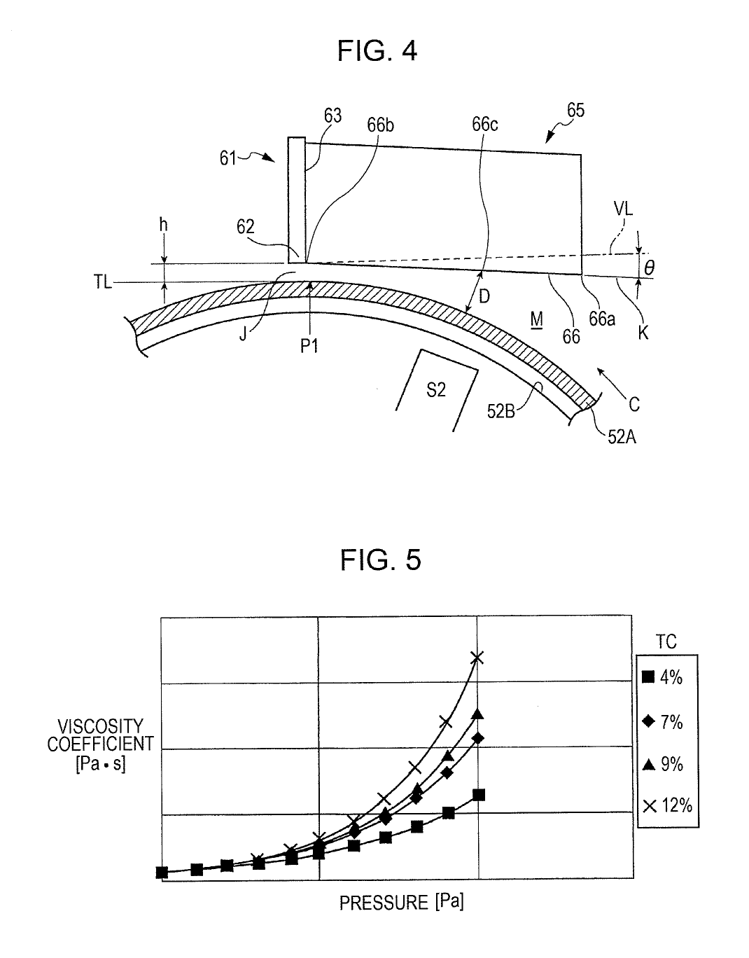

As illustrated in FIGS. 2 to 4, the regulation plate 61 is a rectangular plate having a substantially constant thickness in the principal part and having a length (long side) at least corresponding to the axial length of the sleeve 52A of the second developing roller 52. The regulation plate 61 is formed of a nonmagnetic material (e.g., stainless steel). Further, the regulation plate 61 is attached to the body section 40 in a manner such that one longitudinal end (a lower long side) 62 thereof opposes the outer peripheral surface of the sleeve 52A with a predetermined gap (regulation height) h therebetween and extends in the axial direction of the sleeve 52A (FIG. 4). In the exemplary embodiment, the regulation plate 61 is formed as a plate member bent at the other end to obtain an L-shaped cross section as a whole. The bent other end is fixed to a support member 64 (FIG. 2).

As illustrated in FIGS. 2 to 4, the introduction member 65 is located in contact with a face portion 63 of the regulation plate 61 on an upstream side in the rotating direction C of the sleeve 52A. For example, the introduction member 65 is fixed to the face portion 63 of the regulation plate 61. In the exemplary embodiment, the introduction member 65 is shaped like a thick plate-shaped (prism-shaped) member thicker than the regulation plate 61. For example, the introduction member 65 is formed of ABS resin (acrylonitrile butadiene styrene copolymer). As illustrated in FIG. 4, an introduction space M defined by the opposing face 66 of the introduction member 65 is shaped such that the gap between the opposing face 66 and the outer peripheral surface of the sleeve 52A gradually decreases toward the regulation plate 61 and the longitudinal cross section is wedge-shaped (tapered) as a whole, because the opposing face 66 is flat and the outer peripheral surface of the sleeve 52A is formed by a curved face of the cylinder.

As illustrated in FIG. 4, the opposing face 66 of the introduction member 65 is set such that at least an end (corner) 66a located on an upstream side in the rotating direction C of the sleeve 52A is closer to the outer peripheral surface of the sleeve 52A than a virtual line VL that is obtained by translating a tangent line TL to the sleeve 52A at a position P1 opposing the end 62 of the regulation plate 61 (a corner on the introduction member 65 side) to a position in contact with the end 62 of the regulation plate 61. By virtue of this structure, an entrance of the introduction space M of wedge-shaped cross section is relatively narrow, and it is possible to suppress the increase in pressure caused when the developer G entering the introduction space M is densely gathered by a gradually narrowed physical space while flowing in the introduction space M toward the gap J between the sleeve 52A and the regulation plate 61. For example, even when a change is made in the amount of developer G to be supplied from the screw auger 56 to the sleeve 52A (especially, an increasing change: a slightly undulating change provided in correspondence to the rotation path of the screw, the occurrence of a so-called auger mark), the change is rarely transmitted into the introduction space M.

The end 66a of the opposing face 66 may be set to exist on the virtual line VL. For that purpose, as illustrated in FIG. 4, an angle θ formed between a straight line (plane) K passing through the ends 66a and 66b of the opposing face 66 and the virtual line VL is set to be more than or equal to 0°. When the angle θ is a negative value, it is difficult to obtain the above-described operational effect because the entrance of the introduction space M is relatively wide. The upper limit of the angle θ is set, for example, such that the shortest distance between the opposing face 66 and the outer peripheral surface of the sleeve 52A is not smaller than a regulation height h of the regulation plate 61.

As illustrated in FIG. 4, the end (corner) 66b of the opposing face 66 in contact with the regulation plate 61 is set to be in contact with the end 62 of the regulation plate 61 opposing the sleeve 52A in a state in which a level difference is not formed therebetween. A state in which a level difference is not formed means a state in which the end 66b of the opposing face 66 coincides (is aligned) with the end (corner) 62 of the regulation plate 61. This structure can prevent the pressure from being increased by retention of the developer G, which is introduced in the introduction space M, because of the level difference between the regulation plate 61 and the end 66b of the opposing face 66.

Further, the opposing face 66 is set such that a distance D between a portion 66c of the opposing face 66 opposing the regulation-assist magnetic pole S2 and the outer peripheral surface of the sleeve 52A is more than the regulation height h of the regulation plate 61 (D>h). The portion 66c opposing the magnetic pole S2 corresponds to a position of the peak value in a magnetic force distribution of the magnetic pole S2 in the normal direction. With this structure, it is possible to reliably determine the transport amount of developer G1 passing by the regulation plate 61 by the gap h between the sleeve 52A and the regulation plate 61. In addition, the increase in pressure resulting from magnetic brushes of the developer G formed by the magnetic force (lines) generated at the magnetic pole S2 can be made less than in a case in which the magnetic pole S2 is set at a position opposing the regulation plate 61.

As illustrated in FIGS. 2 and 3, the separating member 42 is a bar-shaped member extending in the axial direction of the two developing rollers 51 and 52 and having a wedge-shaped cross section. The separating member 42 has separation faces 42a and 42b opposing the outer peripheral surfaces of the sleeves 51A and 52A of the developing rollers 51 and 52, respectively. The separating member 42 is set at a position closer to the photoconductor drum 21 than the closest portion 53 between the two developing rollers 51 and 52. A tapered end of the separating member 42 points toward the closest portion 53, and the separation faces 42a and 42b are located at an equal distance from the outer peripheral surfaces of the sleeves 51A and 52A. In actuality, the separating member 42 is attached with attachment portions 43 projecting from both ends being fixed to the side portions of the body section 40.

The guide plate 44 is a plate member having a surface which receives developer G4 separated from the first developing roller 51 and on which the developer G4 slides down and returns to the storage chamber 40a. As illustrated in FIGS. 2 and 3, the guide plate 44 is attached such that an upper end portion 44a thereof opposes the midpoint between the magnetic pole N4 and the magnetic pole N5 serving as the separation poles in the first developing roller 51 and such that a lower end 44b thereof is in contact with a surface 67 of the introduction member 65 opposite the opposing face 66.

Operation of the developing device 4 will be described below.

First, when the image forming apparatus 1 starts an image forming operation, the sleeves 51A and 52A of the two developing rollers 51 and 52 and the screw augers 55 and 56 in the developing device 4 start rotation, and a developing voltage is applied to the sleeves 51A and 52A.

Thus, two-component developer G stored in the storage chamber 40a of the body section 40 is transported in the predetermined directions in the two circulating and transporting paths in the storage chamber 40a while being agitated by the rotating augers 55 and 56, and is transported in a circulation manner as a whole. At this time, nonmagnetic toner in the developer G is frictionally charged by being sufficiently agitated together with magnetic carriers, and is electrostatically attracted on the surfaces of the carriers.

Subsequently, as illustrated in FIG. 3, part of the two-component developer G transported by the screw auger 56 located near the second developing roller 52 is held on the outer peripheral surface of the sleeve 52A of the second developing roller 52 while being attracted by magnetic force. That is, since magnetic force produced from the magnetic pole S3 of the magnet roller 52B acts on the outer peripheral surface of the rotating sleeve 52A, the magnetic carriers on which the toner is attracted are held and supplied while being connected like chains to form cluster-shaped magnetic brushes.

Next, as illustrated in FIG. 3, the two-component developer G held on the second developing roller 52 reaches the entrance of the introduction space M defined by the opposing face 66 of the introduction member 65 during transportation by the rotation of the sleeve 52A.

Then, part of the developer G (developer existing near the outer peripheral surface of the sleeve 52A) is introduced into the introduction space M, and the remaining part (developer distant from the outer peripheral surface of the sleeve 52A) is dammed by shear force from a side face 68 of the introduction member 65, and most of the dammed developer is returned to the storage chamber 40a.

The introduced developer G moves in the introduction space M receiving the magnetic force from the regulation-assist magnetic pole N3, and passes through the gap J provided between the sleeve 52A and the regulation plate 61. At this time, the developer G is restricted in passage to have a substantially constant layer thickness (transport amount).

Next, as illustrated in FIG. 3, developer G1 restricted by the regulation plate 61 is separated in two, that is, into both the first developing roller 51 and the second developing roller 52 while passing by the separating member 42.

In this case, developer G2 separated to the first developing roller 51 is transported by the sleeve 51A rotating in the direction of arrow B, and receives magnetic force from the magnetic pole N3 and is subjected to a developing electric field of the developing voltage while passing through the first developing region E1 of the photoconductor drum 21. Thus, toner in the magnetic brushes of the developer G2 moves to the photoconductor drum 21 and adheres to a latent image passing through the first developing region E1, so that the latent image is developed. Developer G4 that has passed through the first developing region E1 is separated from the outer peripheral surface of the sleeve 51A after passing over the magnetic pole N4 serving as the separation pole, and is then returned to the storage chamber 40a along the guide plate 44.

In contrast, developer G3 separated to the second developing roller 52 is transported by the sleeve 52A rotating in the direction of arrow C, and receives magnetic force from the magnetic pole S1 and is subjected to a developing electric field of the developing voltage while passing through the second developing region E2 of the photoconductor drum 21. Thus, toner in magnetic brushes of the developer G3 moves to the photoconductor drum 21 and adheres to a latent image passing through the second developing region E2, so that the latent image is developed. Developer G5 that has passed through the second developing region E2 passes over the magnetic poles N1 serving as the separation poles, is separated from the outer peripheral surface of the sleeve 52A, and falls free to return in the storage chamber 40a.

In the developing device 4, the developer G supplied to the second developing roller 52 behaves as follows when being introduced in the introduction space M defined by the opposing face 66 of the introduction member 65 and passing through the gap J between the regulation plate 61 and the sleeve 52A.

First, in a developing device in which the introduction member 65 is not provided and the regulation-assist magnetic pole S2 opposes the regulation plate 61, magnetic force (magnetic force line) of the magnetic pole S2 for keep magnetic brushes standing concentrates in the gap J between the regulation plate 61 and the sleeve 52A, and the developer G passing through the gap J is densely gathered and increases the pressure. Hence, the viscosity (fluidity) of the developer G changes (becomes unstable), and the transport amount of developer G1, which has passed through the gap J, changes frequently. FIG. 5 shows the relationship between the pressure and the viscosity coefficient of the developer. In FIG. 5, TC represents the concentration (content) of toner in the two-component developer G. This data is obtained by measurement in a manner similar to that adopted in a permeability test. As shown in FIG. 5, the viscosity coefficient increases as the pressure increases. Further, this tendency becomes more pronounced as the toner concentration TC increases.

This phenomenon in which the transport amount of developer G1, which has passed through the gap J, changes is pronounced when image formation (developing process) is performed at a high process speed (e.g., 600 mm/sec or more) by using developer G including toner having a small particle diameter (e.g., an average particle diameter of 5 μm or less).

Accordingly, as described above, in the developing device 4, the regulation-assist magnetic pole S2 is located at the position shifted from the position opposing the regulation plate 61 toward an upstream side in the rotating direction C of the sleeve 52A, and the introduction member 65 having the specific opposing face 66 defining the introduction space M is located on an upstream side of the regulation plate 61 in the rotation direction C of the sleeve 52A.

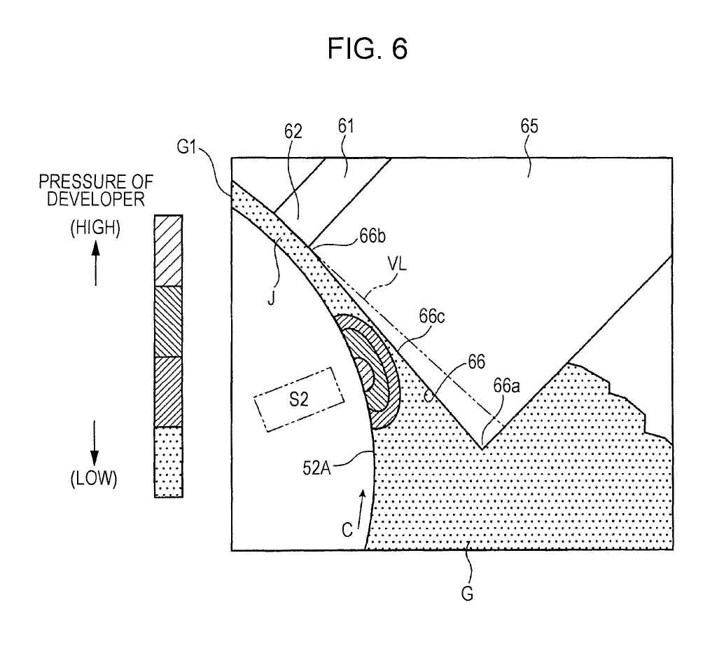

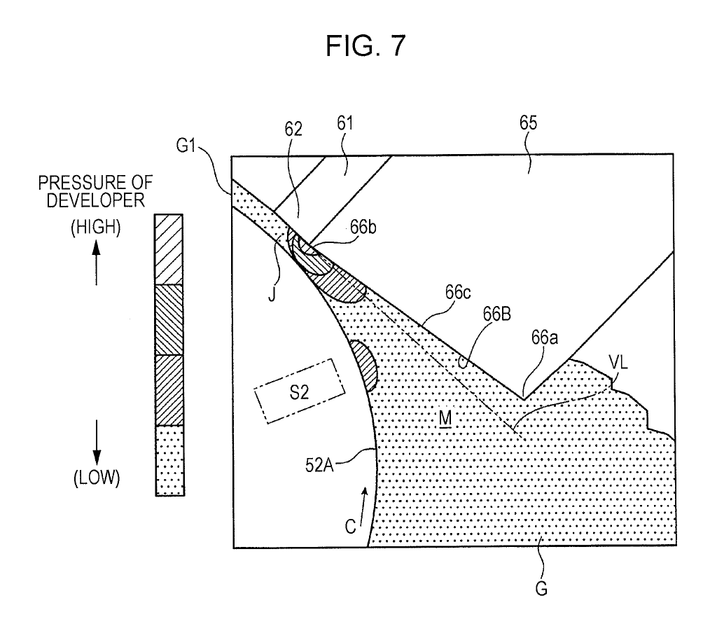

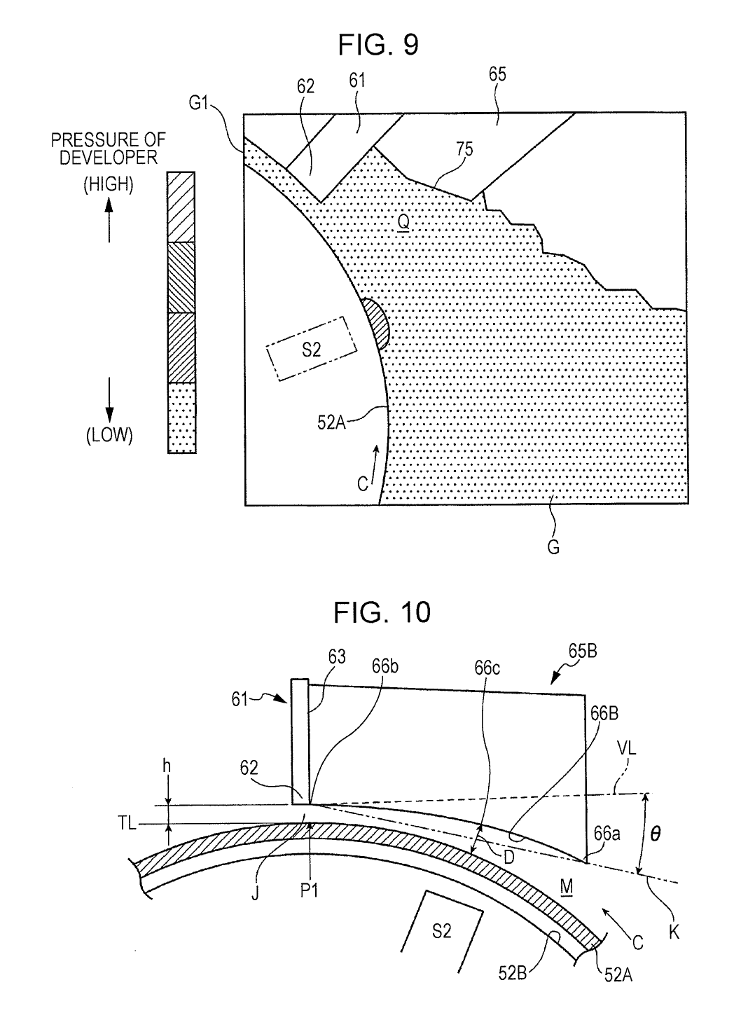

Thus, as illustrated in FIG. 6, the magnetic force of the regulation-assist magnetic pole S2 concentrates and the pressure of the developer G increases at the position on an upstream side of the gap J in the introduction space M, and the pressure (increase) of the developer G in the gap J is reduced. Data shown in FIG. 6 is obtained by continuum analysis using fluid analysis software (this also applies to FIGS. 7 and 9).

As a result, although the pressure of the developer G introduced in the introduction space M is increased and fluidity is reduced by the magnetic force of the magnetic pole S2 at the position on the upstream side of the gap J, the pressure is relatively relaxed and fluidity is enhanced in an area where the developer G passes through the position, reaches the gap J, and passes through the gap J. Hence, at the time when the developer G passes by the regulation plate 61, the transport amount of developer is easily regulated in correspondence to the regulation height h at the gap J. Moreover, the distance D from the portion 66c of the opposing face 66 of the introduction member 65 opposing the magnetic pole S2 and the outer peripheral surface of the sleeve 52A is set to be more than the regulation height h at the gap J (FIG. 4). This allows the developer to easily flow although the magnetic force of the magnetic pole S2 concentrates and the pressure of the developer G increases at that position.

The end 66a of the opposing face 66 of the introduction member 65 located on the upstream side in the rotating direction C of the sleeve 52A is set to be closer to the outer peripheral surface of the sleeve 52A than the virtual line VL. This inhibits the pressure on the developer G, guided in the introduction space M of wedge-shaped cross section, from being increased because the space is narrowed and the developer is densely gathered as it flows toward the tapered end of the introduction space M. Further, since the entrance of the introduction space M is relatively narrow, as described above, even if the amount of developer G to be supplied to the sleeve 52A changes (in particular, increases), the change is rarely transmitted into the introduction space M.

As a result, the pressure is not increased in the area where the developer G introduced in the introduction space M passes immediately before passing through the gap J of the regulation plate 61. Hence, at the time when the developer G passes by the regulation plate 61, the transport amount thereof is easily regulated in correspondence to the regulation height h at the gap J. Moreover, even when the amount of developer G supplied to the sleeve 52A changes (in particular, increases), the change does not have any influence on the transport amount of developer that has passed through the gap J. In addition, the end 66b of the opposing face 66 of the introduction member 65 in contact with the end 62 of the regulation plate 61 is set to coincide with the end 62 without forming any level difference (FIG. 4). Hence, the pressure on the developer will not be increased by the level difference between the end 62 of the regulation plate 61 and the end 66b of the opposing face 66.

From the above, according to the developing device 4, it is possible to inhibit the transport amount of developer G supplied to the second developing roller 52 (sleeve 52A) from being changed after passing by the regulation plate 61 because the pressure most concentrates at the developer G passing through the gap J between the sleeve 52A and the regulation plate 61 and the amount of developer G supplied to the sleeve 52A changes. For this reason, in the developing device 4, the occurrence of nonuniform development resulting from the change (unevenness) in transport amount of developer is suppressed, and an image quality defect, such as nonuniform density, is suppressed in a toner image finally obtained in the image forming apparatus 1. These advantages are especially effective because they are obtained when image formation is performed at high process speed by using the above-described developer G containing small-diameter toner.

In FIG. 7, the introduction member 65 has an opposing face 66B whose end 66a is located at a position farther from the sleeve 52A than the virtual line VL (θ<0°). In this case, developer G guided in the introduction space M of wedge-shaped cross section is positively gathered at the tapered end of the introduction space M by the opposing face 66B, and this increases the pressure. The pressure increased immediately before the gap J is higher than the pressure increased by the magnetic force of the regulation-assist magnetic pole S2 distant from the regulation plate 61.

For this reason, the viscosity (fluidity) of the developer is made unstable by the influence of the pressure increased near the gap J in this case. Therefore, the transport amount of developer G1, which has passed through the gap J, is apt to change.

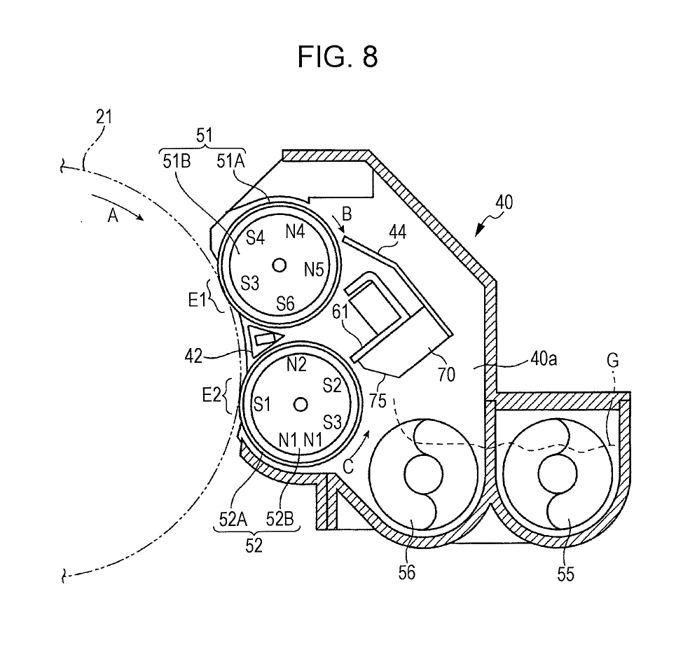

In a case illustrated in FIG. 8, the regulation-assist magnetic pole S2 is located at a position shifted from the position opposing the regulation plate 61 to an upstream side in the rotating direction C of the sleeve 52A, and the above-described introduction member 65 is replaced with an introduction member 70 having an opposing face 75 that is distant from the outer peripheral surface of the sleeve 52A and does not form the introduction space M of wedge-shaped cross section between the opposing face 75 and the sleeve 52A. In this case, a pressure distribution of developer shown in FIG. 9 is provided in an introduction space Q formed between the opposing face 75 of the introduction member 70 and the outer peripheral surface of the sleeve 52A.

In this case, as illustrated in FIG. 9, unlike the introduction member 65 having the opposing face 66 that forms the introduction space M of wedge-shaped cross section (FIG. 7), the pressure of the developer is not increased near the gap J at the regulation plate 61 according to the setting manner of the opposing face 66. However, the entrance of the introduction space Q defined by the opposing face 75 of the introduction member 70 is wider than the entrance of the introduction space M. Hence, if the amount of developer G supplied to the sleeve 52A changes (in particular, increases), the change is easily transmitted into the introduction space Q, and the transport amount of developer G1 that has passed through the gap J at the regulation plate 61 is apt to change. This causes nonuniform development (unevenness corresponding to an auger mark).

### Other Exemplary Embodiments

While the developing device 4 to which the present invention is applied uses two developing rollers 51 and 52 in the above-described exemplary embodiment, the present invention is similarly applicable to a developing device using one developing roller.

While the introduction member 65 has the flat opposing face 66 in the above exemplary embodiment, for example, an introduction member 65B having a curved opposing face 66B can be adopted, as illustrated in FIG. 10. The opposing face 66B of the introduction member 65B in FIG. 10 is shaped to substantially conform to the curved outer peripheral surface of the cylindrical sleeve 52A. In the opposing face 66B, a distance D between a portion 66c opposing the regulation-assist magnetic pole S2 and the outer peripheral surface of the sleeve 52A is also set to be more than the regulation height h at the gap J.

While the end 66b of the opposing face 66 of the introduction member 65 is in contact with the end 62 of the regulation plate 61 without forming any level difference in the above exemplary embodiment, a level difference may be formed as long as it is 0.5 mm or less for example.

The type of the image forming apparatus 1 of the present invention is not particularly limited as long as the image forming apparatus 1 can use the developing device 4.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. A developing device comprising:
a substantially cylindrical developer transport body having an outer peripheral surface that rotates to transport developer showing magnetism;
a magnet member fixed to an inner side of the developer transport body and having a plurality of magnetic poles extending in an axial direction of the developer transport member, the magnetic poles being spaced in a rotating direction of the developer transport body;
a platelike regulation member that regulates passage of the developer supplied on the outer peripheral surface of the developer transport body to maintain a predetermined transport amount of the developer, the regulation member extending in the axial direction of the developer transport body to oppose the outer peripheral surface of the developer transport body with a predetermined gap therebetween; and
an introduction member provided in contact with a face portion of the regulation member on an upstream side in the rotating direction of the developer transport body, and having an opposing face opposing the outer peripheral surface of the developer transport body to form an introduction space where the supplied developer is introduced toward the gap between the regulation member and the developer transport body,
wherein a regulation-assist magnetic pole for assisting in regulation of the regulation member, of the plurality of magnetic poles in the magnet member, is provided at a position shifted from a position opposing the regulation member toward the upstream side in the rotating direction of the developer transport body to oppose a part of the opposing face of the introduction member, and
wherein the opposing face of the introduction member is provided such that at least an end of the opposing face provided on the upstream side in the rotating direction of the developer transport body is located on a virtual line obtained by translating a tangent line to the developer transport body at a position opposing the regulation member to an end of the regulation member opposing the developer transport body or is located closer to the outer peripheral surface of the developer transport body than the virtual line.

2. The developing device according to claim 1, wherein a distance between a portion of the opposing face of the introduction member opposing the regulation-assist magnetic pole and the outer peripheral surface of the developer transport body is more than the gap between the regulation member and the developer transport body.

3. The developing device according to claim 1, wherein an end of the opposing face of the introduction member in contact with the regulation member is in contact with an end of the regulation member opposing the developer transport body without forming a level difference therebetween.

4. The developing device according to claim 2, wherein an end of the opposing face of the introduction member in contact with the regulation member is in contact with an end of the regulation member opposing the developer transport body without forming a level difference therebetween.

5. An image forming apparatus comprising:
a rotary latent-image carrier; and
the developing device according to claim 1, the developing device developing a latent image by supplying developer to the latent-image carrier.
